(19) United States
(12) Patent Application Publication
(10) Pub. No.: US 2018/0194116 A1
(43) Pub. Date: Jul. 12, 2018

(54) Article with Adhesive Composition Having a Block Composite Compatibilizer

(71) Applicant: Dow Global Technologies LLC, Midland, MI (US)

(72) Inventors: Liwen Chen, Shanghai (CN); Yi Jin, Freeport, TX (US); Selim Yalvac, Freeport, TX (US); Allan McLennaghan, Horgen (CH)

(21) Appl. No.: 15/740,490

(22) PCT Filed: Jun. 29, 2015
(86) PCT No.: PCT/CN2015/082652

§ 371 Date: Dec. 28, 2017

(51) Int. Cl. B32B 27/08; B32B 27/32; B32B 7/12; C09J 123/08; C09J 123/16; C09J 153/00; C09J 11/06

(52) U.S. Cl. CPC B32B 27/08; B32B 27/32; B32B 7/12; C09J 123/0807; B32B 2323/10; C09J 153/00; C09J 11/06; B32B 2307/542; C09J 123/16

(57) ABSTRACT

The present disclosure provides an article. The article includes a first substrate comprising a first propylene-based polymer and a second substrate comprising a second propylene-based polymer. The article includes an adhesive composition located between the first substrate and the second substrate. The adhesive composition includes (A) a block composite compatibilizer, (B) an ethylene-based polymer or a propylene-based polymer, (C) a tackifier, and (D) a wax. The adhesive composition bonds the first substrate to the second substrate with improved a lap shear strength.

### BACKGROUND

Adhesion to low surface energy substrates is becoming increasingly important as more and more low surface energy materials (such as plastics) are incorporated into articles to which adhesives and adhesive articles (such as tapes) are required to adhere.

Propylene-based polymer is used in a wide range of technical and industrial applications, such as laminated fabrics in the textile industry, automobile interior coverings and footwear interior such as edge folds and collars. Propylene-based polymer has low surface tension resulting in weak hydrophilic and adhesion properties. Ethylene-based adhesives have poor adhesion to substrates with propylene-based polymer.

The art recognizes a need for an adhesive composition with improved adhesion to substrates composed of propylene-based polymer and articles containing same.

### SUMMARY

The present disclosure is directed to the unexpected discovery that lap shear adhesion to propylene-based polymer substrates is improved significantly utilizing an adhesive composition containing a block composite compatibilizer.

The present disclosure provides an article. In an embodiment, the article includes a first substrate comprising a first propylene-based polymer and a second substrate comprising a second propylene-based polymer. The article includes an adhesive composition located between the first substrate and the second substrate. The adhesive composition includes

(A) a block composite compatibilizer,

(B) an ethylene-based polymer,

(C) a tackifier, and

(D) a wax.

The adhesive composition bonds the first substrate to the second substrate with a lap shear strength from 33.0 MPa to 80.0 MPa.

The present disclosure provides another article. In an embodiment, the article includes a first substrate comprising a first propylene-based polymer and a second substrate comprising a second propylene-based polymer. The article includes an adhesive composition located between the first substrate and the second substrate. The adhesive composition includes

(A) a block composite compatibilizer,

(B) a propylene-based polymer,

(C) a tackifier, and

(D) a wax.

The adhesive composition bonds the first substrate to the second substrate with a lap shear strength from 10.0 MPa to 15.0 MPa.

### BRIEF DESCRIPTION OF THE DRAWING

FIG. 1 is a graph showing three HTLC chromatograms, one for a block composite compatibilizer (identified as BCC1), one for a blend of isotactic polypropylene and TAFMER™ P-0280, and one for a blend of VERSIFY™ 2400 and TAFMER™ P-0280.

### DEFINITIONS

All references to the Periodic Table of the Elements refer to the Periodic Table of the Elements published and copyrighted by CRC Press, Inc., 1990. Also, any references to a Group or Groups shall be to the Group or Groups reflected in this Periodic Table of the Elements using the IUPAC system for numbering groups. Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, product and processing designs, polymers, catalysts, definitions (to the extent not inconsistent with any definitions specifically provided in this disclosure), and general knowledge in the art.

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Density is measured in accordance with ASTM D 792, reported in gram (g) per cubic centimeter (cc), or g/cc.

An “ethylene-based polymer,” as used herein is a polymer that contains more than 50 mole percent polymerized ethylene monomer (based on the total amount of polymerizable monomers) and, optionally, may contain at least one comonomer.

Melt flow rate (MFR) is measured in accordance with ASTM D 1238, Condition 280° C./2.16 kg (g/10 minutes).

Melt index (MI) is measured in accordance with ASTM D 1238, Condition 190° C./2.16 kg (g/10 minutes).

Shore A hardness is measured in accordance with ASTM D 2240.

Tm or “melting point” as used herein (also referred to as a melting peak in reference to the shape of the plotted DSC curve) is typically measured by the DSC (Differential Scanning Calorimetry) technique for measuring the melting points or peaks of polyolefins as described in U.S. Pat. No. 5,783,638. It should be noted that many blends comprising two or more polyolefins will have more than one melting point or peak, many individual polyolefins will comprise only one melting point or peak.

“Propylene-based polymer,” and like terms mean a polymer that comprises a majority weight percent polymerized propylene monomer (based on the total amount of polymerizable monomers), and optionally comprises at least one polymerized comonomer different from propylene (such as at least one selected from a C₂ and C₄₋₁₀ α-olefin) so as to form a propylene-based interpolymer. For example, when the propylene-based polymer is a copolymer, the amount of propylene is greater than 50 wt %, based on the total weight of the copolymer. “Units derived from propylene” and like terms mean the units of a polymer that formed from the polymerization of propylene monomers. “Units derived from α-olefin” and like terms mean the units of a polymer that formed from the polymerization of α-olefin monomers, in particular at least one of a C₃₋₁₀ α-olefin.

“Ethylene-based polymer” and like terms mean a polymer that comprises a majority weight percent polymerized ethylene monomer (based on the total weight of polymerizable monomers), and optionally may comprise at least one polymerized comonomer different from ethylene (such as at least one selected from a C₃₋₁₀ α-olefin) so as to form an ethylene-based interpolymer. For example, with the ethylene-based polymer is a copolymer, the amount of ethylene is greater than 50 wt %, based on the total weight to the copolymer.

The term “block copolymer” or “segmented copolymer” refers to a polymer comprising two or more chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), regio-regularity or regio-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalysts (such as those described in the examples).

The term “block composite” (BC) refers to polymers comprising a soft copolymer having a comonomer content that is greater than 10 mol % and less than 90 mol %, a hard polymer having a monomer content, and a block copolymer (e.g., a diblock having a soft segment, and a hard segment), wherein the hard segment of the block copolymer is essentially the same composition as the hard polymer in the block composite and the soft segment of the block copolymer is essentially the same composition as the soft copolymer of the block composite.

“Hard” segments/blocks refer to highly crystalline blocks of polymerized units. The hard segments have a monomer (such as propylene) and a remainder may be a comonomer (such as ethylene). In some embodiments, the hard segments comprise all or substantially all propylene units (such as an iPP—isotactic polypropylene homopolymer block). “Soft” segments/blocks refer to amorphous, substantially amorphous, or elastomeric blocks of polymerized units. In the soft segments, the comonomer (such as ethylene) may be present and a remainder may be the monomer (such as propylene).

The term “crystalline” refers to a polymer or polymer block that possesses a first order transition or crystalline melting point (Tm) as determined by differential scanning calorimetry (DSC) or equivalent technique. The term may be used interchangeably with the term “semicrystalline”.

The term “crystallizable” refers to a monomer that can polymerize such that the resulting polymer is crystalline. Crystalline propylene polymers may have, but are not limited to, densities of 0.88 g/cc to 0.91 g/cc and melting points of 100° C. to 170° C.

The term “amorphous” refers to a polymer lacking a crystalline melting point as determined by differential scanning calorimetry (DSC) or equivalent technique.

The term “isotactic” is defined as polymer repeat units having at least 70 percent isotactic pentads as determined by ¹³C-NMR analysis. “Highly isotactic” is defined as polymers having at least 90 percent isotactic pentads.

“Q.S.” or “q.s.” means quantum sufficit or quantity sufficient or in other words, enough of the ingredient, i.e., wax, is added to the adhesive formulation to bring it to completion, i.e., to 100 wt %. For example, if the adhesive formulation contained 30 wt % ethylene-based polymer, 10 wt % propylene-based polymer, 10 wt % BCC, and 15 wt % tackifier, then the q.s. for the wax is 35 wt %.

### DETAILED DESCRIPTION

The present disclosure provides an article. In an embodiment, the article includes a first substrate comprising a first propylene-based polymer, a second substrate comprising a second propylene-based polymer. An adhesive composition is located between the first substrate and the second substrate. The adhesive composition comprises (A) a block composite, (B) an ethylene-based polymer, (C) a tackifier, and (D) a wax. The adhesive composition bonds the first substrate to the second substrate with a lap shear strength from 33.0 MPa to 80.0 MPa.

### 1. Substrates

The article includes a first substrate and a second substrate. The first substrate includes the first propylene-based polymer, and the second substrate includes the second propylene-based polymer. A portion of the first substrate and a portion of the second substrate each may be composed of the respective first propylene-based polymer and the second propylene-based polymer. Alternatively, the first substrate and the second substrate each may be composed entirely of the respective first propylene-based polymer and the second propylene-based polymer.

The first propylene-based polymer and the second propylene-based polymer may be the same or may be different. In an embodiment, the first propylene-based polymer is the same as the second propylene-based polymer.

In an embodiment, the first propylene-based polymer is different than the second propylene-based polymer.

The first substrate and the second substrate can be flexible or can be rigid.

Nonlimiting examples of suitable propylene-based polymer for the first propylene-based polymer and the second propylene-based polymer include propylene homopolymers, propylene interpolymers, as well as reactor copolymers of polypropylene (RCPP), which can contain about 1 to about 20 weight percent ethylene or an alpha-olefin comonomer of 4 to 20 carbon atoms (e.g., C₂ and C₄-C₁₀ alpha-olefins). The propylene-based interpolymer can be a random or block copolymer, or a propylene-based terpolymer. Examplary, comonomers for polymerizing with propylene include ethylene, 1-butene, 1-pentene, 1-hexene, 1-heptene, 1-octene, 1-nonene, 1-decene, 1-unidecene, 1 dodecene, as well as 4-methyl-1-pentene, 4-methyl-1-hexene, 5-methyl-1-hexene, vinylcyclohexane, and styrene. Exemplary comonomers include ethylene, 1-butene, 1-hexene, and 1-octene.

Exemplary propylene-based interpolymers include propylene/ethylene, propylene/1-butene, propylene/1-hexene, propylene/4-methyl-1-pentene, propylene/1-octene, propylene/ethylene/1-butene, propylene/ethylene/EN B, propylene/ethylene/1-hexene, propylene/ethylene/1-octene, propylene/styrene, and propylene/ethylene/styrene.

Optionally, the propylene-based polymer includes a monomer having at least two double bonds such as dienes or trienes. Exemplary diene and triene comonomers include 7-methyl-1,6-octadiene; 3,7-dimethyl-1,6-octadiene; 5,7-dimethyl-1,6-octadiene; 3,7,11-trimethyl-1,6,10-octatriene; 6-methyl-1,5heptadiene; 1,3-butadiene; 1,6-heptadiene; 1,7-octadiene; 1,8-nonadiene; 1,9-decadiene; 1,10-undecadiene; norbornene; tetracyclododecene; or mixtures thereof. Exemplary embodiments include a butadiene, a hexadienes, and/or an octadiene. Examples include 1,4-hexadiene; 1,9-decadiene; 4-methyl-1,4-hexadiene; 5-methyl-1,4-hexadiene; dicyclopentadiene; and 5-ethylidene-2-norbornene (ENB).

Other unsaturated comonomers include, e.g., 1,3-pentadiene, norbornadiene, and dicyclopentadiene; C₈₋₄₀ vinyl aromatic compounds including styrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene.

Exemplary propylene-based polymers are formed using single site catalysts (metallocene or constrained geometry) or Ziegler Natta catalysts. Exemplary, polypropylene polymers include KS 4005 polypropylene copolymer (previously available from Solvay); KS 300 polypropylene terpolymer (previously available from Solvay); L-Modu™ polymers, available from Idemistu, and VERSIFY™ polymers, available from The Dow Chemical Company. The propylene and comonomers, such as ethylene or alpha-olefin monomers may be polymerized under conditions within the skill in the art, for instance, as disclosed by Galli, et al., Angew. Macromol. Chem., Vol. 120, 73 (1984), or by E. P. Moore, et al. in Polypropylene Handbook, Hanser Publishers, New York, 1996, particularly pages 11-98.

### 2. Adhesive Composition

The adhesive composition of the present article is located, or is otherwise disposed, between the first substrate and the second substrate. In an embodiment, the adhesive composition is in the form of an adhesive layer. The adhesive layer can be a uniform adhesive layer. Alternatively, the adhesive layer can be an intermittent adhesive layer located between the first substrate and the second substrate.

The adhesive composition includes (A) a block composite compatibilizer, (B) an ethylene-based polymer, (C) a tackifier, and (D) a wax.

A. Block Composite Compatibilizer

The adhesive composition includes a block composite compatibilizer, or BCC. The amount of block composite compatabilizer in the composition is from 1 wt % to 60 wt %, based on the total weight of the adhesive composition. For example, the amount of the block composite compatibilizer in the adhesive composition may be from 3 wt %, or 5 wt %, or 7 wt %, or 10 wt %, or 15 wt %, or 20 wt %, or 25 wt %, to 30 wt %, or 35 wt %, or 40 wt %, or 50 wt %, or 55 wt %, or 60 wt %, based on the total weight of the adhesive composition.

The block composite compatibilizer (BCC), is a polymer comprising (i) a soft copolymer in which the comonomer (such one ethylene) content is greater than 10 wt % and less than 95 wt %, (ii) a hard polymer in which the monomer (such as propylene) is present in an amount greater than 80 wt % and up to 100 wt %, and (iii) a block copolymer such as a diblock, having a soft segment and a hard segment, wherein the hard segment of the block copolymer is the same as, or essentially the same as, the composition of the hard polymer (i) in the block composite compatibilizer, and the soft segment of the block copolymer is the same as, or essentially the same as, the composition as the soft copolymer (ii) of the block composite compatibilizer.

As used herein, “hard” segments/blocks refer to highly crystalline blocks of polymerized units. In the hard segments, the monomer (such as propylene) may be present in an amount greater than 80 wt % (e.g., greater than 85 wt %, or greater than 90 wt %, or greater than 95 wt %, or greater than 98 wt %). The remainder in the hard segment may be the comonomer, such as ethylene in an amount less than 20 wt % (or less than 15 wt %, or less than 10 wt %, or less than 5 wt %, or less than 2 wt %). In some embodiments, the hard segments comprise all, or substantially all, propylene units (such as an iPP—isotactic polypropylene homopolymer block). “Soft” segments/blocks refer to amorphous, substantially amorphous, or elastomeric blocks of polymerized units. In the soft segments, the comonomer (such as ethylene) may be present in an amount greater than 20 wt % and equal to or less than 100 wt % (e.g., from 50 wt % to 99 wt % and/or from 60 wt % to 80 wt %). The remainder in the soft block may be the monomer, such as propylene.

Block composite compatibilizer may be differentiated from conventional, random copolymers, and physical blends of polymers. The block composite compatibilizer may be differentiated from random copolymers and from a physical blend by characteristics such as microstructure index, better tensile strength, improved fracture strength, finer morphology, improved optics, and/or greater impact strength at lower temperature. For example, the block composite compatibilizer includes a block copolymer having distinct regions or segments (referred to as “blocks”) joined in a linear manner. The blocks differ, e.g., in the type of crystallinity such as polyethylene versus polypropylene. The block copolymers can be linear or branched. When produced in a continuous process, the block composites may possess PDI from 1.7 to 15 (e.g., from 1.8 to 10, from 1.8 to 5, and/or from 1.8 to 3.5). When produced in a batch or semi-batch process, the block composites may possess PDI from 1.0 to 2.9 (e.g., from 1.3 to 2.5, from 1.4 to 2.0, and/or from 1.4 to 1.8). Such block composites are described in, e.g., U.S. Patent Application Publication Nos. 2011-0313106, 2011-0313108, and 2011-0313108, all published on Dec. 22, 2011, incorporated herein by reference with respect to descriptions of the block composites, processes to make them, and methods of analyzing them.

The block composite compatibilizer has a microstructure index from greater than 1.0, or 1.5, or 2.0, or 2.5, or 3.0, or 3.5, or 4.0, or 5.0, or 7.5, or 10.0 to 11.0, or 12.5, or 15.0, or 17.5, or 19.0, or 19.5, or less than 20.0. The microstructure index is an estimation using solvent gradient interaction chromatography (SGIC) separation to differentiate between block copolymers from random copolymers. In particular, microstructure index estimation relies on differentiating between two fractions, i.e., a higher random copolymer content fraction and a higher block copolymer content fraction, of which the random copolymer and the block copolymer have essentially the same chemical composition. The early eluting fraction (i.e., the first fraction) correlates to random copolymers and the late eluting component (i.e., the second fraction) correlates to block copolymers. The calculation of the microstructure index is discussed below.

In an embodiment, the microstructure index for the block composite compatibilizer is from greater than 1.0, or 1.1, or 1.2, or 1.3 to 1.5, or 1.7, or 1.9, or 2.0, or 2.2, or 2.3, or 2.4, or 2.5.

In an embodiment, the block composite compatibilizer includes (i) a propylene-based polymer (hard polymer), (ii) an ethylene-based polymer (soft polymer), and (iii) a propylene-ethylene block copolymer having (1) 30-70 wt % hard block and (2) 70-30 wt % soft block. For example, the block copolymer may include from 40 wt % to 60 wt %, or from 45 wt % to 55 wt % of the hard block and from 40 wt % to 60 wt %, or from 45 wt % to 55 wt % of the soft block. The amount of the hard block may be the same as the amount of the soft block (i.e., 50 wt % to 50 wt %). The hard block may comprise from 0 wt %, or greater than 0 wt % to 20 wt % (e.g., from 3 wt %, or 5 wt % to 15 wt %, or 20 wt %) units derived from ethylene and remainder derived from propylene. The soft block may be 50-84 wt % (e.g., greater than 60 wt % and less than 80 wt %) units derived from ethylene and remainder derived from propylene.

In an embodiment, the block copolymer has the formula (EP)-(iPP), in which EP represents a soft block of polymerized ethylene (E) and propylene (P) monomeric units (e.g., from 50 wt % to 84 wt % of ethylene and remainder propylene), and iPP represents a hard block of isotactic propylene homopolymer. In adhesive compositions, it is believed the EP block provides low temperature flexibility and the iPP block provides high temperature resistance. Accordingly, the these two phases may be compatible and deliver improved mixing, robust processability, and good mechanical properties sought in adhesive compositions, such as hot melt adhesive compositions, for example. Further, the crystallization of the iPP block and the EP block may be individually tuned to satisfy a wide range of open time and set time requirements for many different market segments.

In an embodiment, the block copolymer has the formula (EP)-(PE), in which EP represents a soft block of polymerized ethylene and propylene monomeric units (e.g., from 50 wt % to 84 wt % of ethylene and remainder propylene) and PE represents a hard block of polymerized propylene and ethylene monomeric units (e.g., from 3 wt % to 20 wt % of ethylene with remainder propylene). In adhesive compositions, it is believed the EP block provides low temperature flexibility and the PE block provides high temperature resistance. Accordingly, the these two phases may be compatible and deliver improved mixing, robust processability, and good mechanical properties sought in hot melt adhesives. Further, the crystallization of the PE block and the EP block may be individually tuned to satisfy a wide range of open time and set time requirements for many different market segments. The EP-PE diblock may be used alone in the adhesive composition or may be combined with an ethylene-based polymer and/or propylene-based polymer. For example, the EP-PE diblock may be used with the ethylene-based polymer and the propylene-based polymer may be excluded in the adhesive composition; or the EP-PE diblock may be used with a blend of the ethylene and propylene based polymers.

In an embodiment, the block composite compatibilizer includes a block copolymer having a 50/50 (soft/hard) block ratio, with the hard block being propylene ethylene with 6 wt % ethylene and the soft block being ethylene propylene with 65 wt % ethylene.

In an embodiment, the block composite compatibilizer includes a block copolymer having a 50/50 (soft/hard) block ratio, with the hard block being propylene ethylene with 14 wt % ethylene and the soft block being ethylene propylene with 75 wt % ethylene.

In an embodiment, the block composite compatibilizer includes a block copolymer having a 85/15 (soft/hard) block ratio, with the hard block being propylene ethylene with 0 wt % ethylene and the soft block being ethylene propylene with 65 wt % ethylene.

The block composite compatibilizer may be prepared by a process comprising contacting an addition polymerizable monomer or mixture of monomers under addition polymerization conditions with a composition comprising at least one addition polymerization catalyst, one or more cocatalyst (e.g., two cocatalysts) and a chain shuttling agent. The process may be characterized by formation of at least some of the growing polymer chains under differentiated process conditions in two or more reactors operating under steady state polymerization conditions or in two or more zones of a reactor operating under plug flow polymerization conditions.

Suitable processes useful in producing the block composite compatibilizer may be found, e.g., in U.S. Patent Application Publication No. 2008/0269412, published on Oct. 30, 2008, which is herein incorporated by reference. In particular, the polymerization is desirably carried out as a continuous polymerization, preferably a continuous, solution polymerization, in which catalyst components, monomers, and optionally solvent, adjuvants, scavengers, and polymerization aids are continuously supplied to one or more reactors or zones and polymer product continuously removed therefrom. Within the scope of the terms “continuous” and “continuously” as used in this context are those processes in which there are intermittent additions of reactants and removal of products at small regular or irregular intervals, so that, over time, the overall process is substantially continuous. Moreover, the chain shuttling agent(s) may be added at any point during the polymerization including in the first reactor or zone, at the exit or slightly before the exit of the first reactor, or between the first reactor or zone and the second or any subsequent reactor or zone. Due to the difference in monomers, temperatures, pressures or other difference in polymerization conditions between at least two of the reactors or zones connected in series, polymer segments of differing composition such as comonomer content, crystallinity, density, tacticity, regio-regularity, or other chemical or physical difference, within the same molecule are formed in the different reactors or zones. The size of each segment or block is determined by continuous polymer reaction conditions, and preferably is a most probable distribution of polymer sizes.

In an embodiment, the block composite compatibilizer includes

(i) a hard polymer that includes propylene;

(ii) a soft polymer that includes ethylene; and

(iii) a block copolymer having a soft block and a hard block, the hard block of the block copolymer having the same composition as the hard polymer (i) and the soft block of the block copolymer having the same composition as the soft polymer (ii).

In an embodiment, the block composite compatibilizer includes

(i) from 30 wt % to 70 wt % hard polymer comprising greater than 90 mol % propylene;

(ii) from 30 wt % to 70 wt % soft polymer comprising greater than 60 mol % ethylene; and

(iii) the block copolymer.

In an embodiment, the block copolymer (iii) of the block composite compatibilizer includes 50/50 soft block/hard block ratio. The soft block includes greater than or equal to 65 wt % ethylene and the hard block includes from 1 wt % to 10 wt % ethylene.

B. Ethylene-Based Polymer

The adhesive composition includes an ethylene-based polymer. The ethylene-based polymer is present in the adhesive composition to the exclusion of propylene-based polymer (with exception to the block composite compatibilizer which contains a propylene-based polymer). The ethylene-based polymer is present in the adhesive composition in an amount from 10 wt %, or 15 wt %, or 20 wt %, or 25 wt %, or 30 wt % to 35 wt %, or 40 wt %, or 45 wt %, or 50 wt %, or 55 wt %, or 60 wt %, based on the total weight of the adhesive composition.

In an embodiment, the ethylene-based polymer is an ethylene/α-olefin copolymer. The ethylene/α-olefin copolymer is prepared by polymerizing ethylene with a comonomer. Nonlimiting examples of suitable comonomers include alpha-olefin (α-olefin) of 3 to 20 carbon atoms (C₃-C₂₀), α-olefin, of 4 to 20 carbon atoms (C₄-C₂₀), α-olefin, of 4 to 12 carbon atoms (C₄-C₁₂), α-olefin, of 4 to 10 carbon atoms (C₄-C₁₀), and/or α-olefin of 4 to 8 carbon atoms (C₄-C₈). The alpha-olefins include, but are not limited to, 1-butene, 1-pentene, 1-hexene, 4-methyl-1-pentene, 1-heptene, and 1-octene.

In an embodiment, the α-olefin is a C₄-C₈ α-olefin and is selected from 1-butene, 1-pentene, 1-hexene, 4-methyl-1-pentene, 1-heptene, and 1-octene.

Exemplary ethylene/C₄-C₈ α-olefin copolymers include, but are not limited to, ethylene/butene (EB) copolymers, ethylene/hexene (EH), ethylene/octene (EO) and ethylene/propylene (EP) copolymers.

In an embodiment, the ethylene-based polymer is an ethylene/octene copolymer.

In an embodiment, the ethylene/alpha-olefin polymer is a homogeneously branched linear or homogeneously branched substantially linear ethylene/alpha-olefin interpolymer. The terms “homogeneous” and “homogeneously-branched” are used in reference to an ethylene/alpha-olefin polymer (or interpolymer), in which the comonomer(s) is randomly distributed within a given polymer molecule, and substantially all of the polymer molecules have the same ethylene-to-comonomer(s) ratio. The homogeneously branched ethylene interpolymers include linear ethylene interpolymers, and substantially linear ethylene interpolymers. Exemplary processes for preparing homogeneous polymers are disclosed in, e.g., U.S. Pat. Nos. 5,206,075 and 5,241,031 and International Publication No. WO 93/03093.

In an embodiment, the ethylene-based polymer is an ethylene/α-olefin interpolymer and may include a diene. Exemplary diene monomers include conjugated and nonconjugated dienes. The nonconjugated diolefin can be a C₅-C₁₅ straight chain, branched chain or cyclic hydrocarbon diene. Illustrative nonconjugated dienes are straight chain acyclic dienes, such as 1,4-hexadiene and 1,5-heptadiene; branched chain acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene and mixed isomers of dihydromyrcene; single ring alicyclic dienes, such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes, such as 5-methylene-2-norbornene (MNB), 5-ethylidene 2 norbornene (ENB), 5-vinyl-2-norbornene, 5-propenyl-2-norbornene, 5-isopropyldene2norbornene, 5-(4-cyclopentenyl)-2-norbornene and 5-cyclohexylidene-2-norbornene. Exemplary nonconjugated dienes include ENB, 1,4-hexadiene, 7-methyl-1,6-octadiene. Suitable conjugated dienes include 1,3-pentadiene, 1,3-butadiene, 2-methyl-1,3-butadiene, 4-methyl-1,3-pentadiene, 1,3-cyclopentadiene.

In an embodiment, the ethylene/α-olefin interpolymer can be an ethylene/alpha-olefin/diene modified (EAODM) interpolymer such as ethylene/propylene/diene modified (EPDM) interpolymer and ethylene/propylene/octene terpolymer.

The weight average molecular weight (Mw) of the ethylene-based polymers used in may be at least 5000, at least 10000, and/or at least 15000, grams per mole (g/mol). The maximum Mw of the ethylene-based polymers may not exceed 60,000, may not exceed 45,000, and/or may not exceed 30,000, grams per mole (g/mol). The molecular weight distribution or polydispersity or Mw/Mn of these polymers may be less than 5, or be between 1 and 5, and/or be between 1.5 and 4. Weight average molecular weight (Mw) and number average molecular weight (Mn) and can be determined by known methods.

The melt index (I₂) of the ethylene-based polymer is from 5 grams per ten minutes (g/10 min) to 2,000 g/10 min. For example, the melt index may be at least 500 g/10 min. The maximum melt index may not exceed 2000 g/10 min. The melt index is measured by ASTM D1238 (Condition E) (190° C./2.16 kg). The ethylene-based polymer may have a Brookfield viscosity (at 350° F./177° C. as measured using a Brookfield viscometer) of less than 50,000 centipoise (cP). For example, the Brookfield viscosity may be greater than 20,000 cP and less than 50,000 cP (e.g., between 20,000 cP and 50,000 cP).

The density of the ethylene-based polymer may be between 0.850 g/cc and 0.900 g/cc. In exemplary embodiments, the density of the ethylene-based polymer is from 0.860 g/cc to 0.895 g/cc, from 0.860 g/cc to 0.885 g/cc, or from 0.865 g/cc to 0.890 g/cc.

In an embodiment, the ethylene-based polymer is an ethylene/C₄-C₈ α-olefin copolymer and has one, some, or all of the following properties:

(i) a density from 0.0860 g/cc, or 0.865 g/cc to 0.880 g/cc, or 0.885 g/cc, or 0.890 g/cc;

(ii) a melt index (MI) from 10 g/10 min, or 20 g/10 min, or 30 g/10 min, or 40 g/10 min; and

(iii) a melting point, Tm, from 50° C., or 60° C., or 65° C. to 70° C., or 80° C., or 90° C., or 95° C., or 99° C.

Nonlimiting examples of suitable ethylene/C₄-C₈ α-olefin copolymer include polymers sold under the tradenames ENGAGE™ and AFFINITY™, available from The Dow Chemical Company.

C. Tackifier

The adhesive composition includes a tackifier. The amount of the tackifier is from greater than zero, or 1 wt %, or 5 wt %, or 10 wt %, or 15 wt %, or 20 wt %, or 25 wt %, or 30 wt % to 35 wt %, or 40 wt %, or 45 wt %, or 50 wt %, or 55 wt %, or 60 wt %, or 65 wt % up to 70 wt % of the total weight of the adhesive composition.

The tackifier may have a Ring and Ball softening temperature (measured in accordance with ASTM E 28) from 90° C., or 93° C., or 95° C., or 97° C., or 100° C., or 105° C., or 110° C. to 120° C., or 130° C., or 140° C., or 150° C. The tackifier may modify the properties of the adhesive composition such as viscoelastic properties (e.g., tan delta), rheological properties (e.g., viscosity), tackiness (e.g., ability to stick), pressure sensitivity, and wetting property. In some embodiments, the tackifier is used to improve the tackiness of the composition. In other embodiments, the tackifier is used to reduce the viscosity of the composition. In particular embodiments, the tackifier is used to wet out adherent surfaces and/or improve the adhesion to the adherent surfaces.

Tackifiers suitable for the compositions disclosed herein can be solids, semi-solids, or liquids at room temperature. Non-limiting examples of tackifiers include (1) natural and modified rosins (e.g., gum rosin, wood rosin, tall oil rosin, distilled rosin, hydrogenated rosin, dimerized rosin, and polymerized rosin); (2) glycerol and pentaerythritol esters of natural and modified rosins (e.g., the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin); (3) copolymers and terpolymers of natured terpenes (e.g., styrene/terpene and alpha methyl styrene/terpene); (4) polyterpene resins and hydrogenated polyterpene resins; (5) phenolic modified terpene resins and hydrogenated derivatives thereof (e.g., the resin product resulting from the condensation, in an acidic medium, of a bicyclic terpene and a phenol); (6) aliphatic or cycloaliphatic hydrocarbon resins and the hydrogenated derivatives thereof (e.g., resins resulting from the polymerization of monomers consisting primarily of olefins and diolefins); (7) aromatic hydrocarbon resins and the hydrogenated derivatives thereof; (8) aromatic modified aliphatic or cycloaliphatic hydrocarbon resins and the hydrogenated derivatives thereof; and combinations thereof.

In an embodiment, the tackifier includes aliphatic, cycloaliphatic and aromatic hydrocarbons and modified hydrocarbons and hydrogenated versions; terpenes and modified terpenes and hydrogenated versions; and rosins and rosin derivatives and hydrogenated versions; and mixtures of two or more of these tackifiers. These tackifying resins have a ring and ball softening point from 70° C. to 150° C., and will typically have a viscosity at 350° F. (177° C.), as measured using a Brookfield viscometer, of no more than 2000 centipoise. They are also available with differing levels of hydrogenation, or saturation, which is another commonly used term. Useful examples include EASTOTAC™ H-100, H-115 and H-130 from Eastman Chemical Co. in Kingsport, Tenn., which are partially hydrogenated cycloaliphatic petroleum hydrocarbon resins with softening points of 100° C., 115° C. and 130° C., respectively. These are available in the E grade, the R grade, the L grade and the W grade, indicating differing levels of hydrogenation with E being the least hydrogenated and W being the most hydrogenated. The E grade has a bromine number of 15, the R grade a bromine number of 5, the L grade a bromine number of 3 and the W grade has a bromine number of 1. EASTOTAC™ H-142R from Eastman Chemical Co. has a softening point of about 140° C. Other useful tackifying resins include ESCOREZ™ 5300, 5400, and 5637, partially hydrogenated aliphatic petroleum hydrocarbon resins, and ESCOREZ™ 5600, a partially hydrogenated aromatic modified petroleum hydrocarbon resin all available from Exxon Chemical Co. in Houston, Tex.; WINGTACK™. Extra, which is an aliphatic, aromatic petroleum hydrocarbon resin available from Goodyear Chemical Co. in Akron, Ohio; HERCOLITE™ 2100, a partially hydrogenated cycloaliphatic petroleum hydrocarbon resin available from Hercules, Inc. in Wilmington, Del.; NORSOLENE™ hydrocarbon resins from Cray Valley; and ARKON™ water white, hydrogenated hydrocarbon resins available from Arakawa Europe GmbH.

In an embodiment, the tackifier includes aliphatic hydrocarbon resins such as resins resulting from the polymerization of monomers consisting of olefins and diolefins (e.g., ESCOREZ™ 1310LC, ESCOREZ™ 2596 from ExxonMobil Chemical Company, Houston, Tex. or PICCOTAC™ 1095, PICCOTAC™ 9095 from Eastman Chemical Company, Kingsport, Tenn.) and the hydrogenated derivatives thereof; alicyclic petroleum hydrocarbon resins and the hydrogenated derivatives thereof (e.g., ESCOREZ™ 5300 and 5400 series from ExxonMobil Chemical Company; EASTOTAC™ resins from Eastman Chemical Company). In some embodiments, the tackifiers include hydrogenated cyclic hydrocarbon resins (e.g., REGALREZ™ and REGALITE™ resins from Eastman Chemical Company).

In an embodiment the tackifying agent is free of groups with which the silanol group of either the silane-grafted amorphous polyalpha-olefin or the silane-grafted ethylene/α-olefin multi-block copolymer will react.

D. Wax

The adhesive composition includes a wax. The amount of the wax is from 1 wt % to 40 wt % (e.g., from 1 wt % to 30 wt %, or from 3 wt % to 25 wt %, or from 5 wt % to 20 wt %, etc.). For example, the amount of the wax is from greater than zero, or 1 wt %, or 5 wt %, or 10 wt %, or 15 wt %, or 20 wt %, or 25 wt %, or 30 wt %, or 40 wt % of the total weight of the adhesive composition.

The wax may be used to reduce the melt viscosity of the adhesive composition. Non-limiting examples of suitable waxes include paraffin waxes, microcrystalline waxes, polyethylene waxes, polypropylene waxes, by-product polyethylene waxes, Fischer-Tropsch waxes, oxidized Fischer-Tropsch waxes and functionalized waxes such as hydroxy stearamide waxes and fatty amide waxes. Nonlimiting examples of suitable waxes include H1, C80, H105, H8, C80M available from Sasol; A-C® line wax available from Honeywell; Licocene® polyethylene wax available from Clariant and CHU561, CHU610, CWP500 etc. available from Trecora™

E. Additives and Fillers

The adhesive composition can optionally include one or more additives and/or fillers (different and separate from the tackifier, wax, and oil). Nonlimiting examples of additives include plasticizers thermal stabilizers, light stabilizers (e.g., UV light stabilizers and absorbers), optical brighteners, antistats, lubricants, antioxidants, catalysts, rheology modifiers, biocides, corrosion inhibitors, dehydrators, organic solvents, colorants (e.g., pigments and dyes), surfactants antiblocking agents, nucleating agents, flame retardants and combinations thereof. Nonlimiting examples of fillers include fumed silica, precipitated silica, talc, calcium carbonates, carbon black, aluminosilicates, clay, zeolites, ceramics, mica, titanium dioxide, and combinations thereof. Nonlimiting examples of nucleating agents include, 3:2,4-di-p-methyl-dibenzilidene sorbitol.

For example, the adhesive composition may including an antioxidant, in which antioxidant refers to types or classes of chemical compounds that are capable of being used to minimize the oxidation that can occur during the processing of polymers. The term also includes chemical derivatives of the antioxidants, including hydrocarbyls. The term further includes chemical compounds, as described later in the description of the antioxidant, that when properly combined with the coupling agent (modifying agent) interact with to form a complex which exhibits a modified Raman spectra compared to the coupling agent or modifying agent alone. The amount of the antioxidant may be less than 1 wt %, based on the total weight of the adhesive composition.

The components of the adhesive composition may be melt blended together to form the adhesive composition. Nonlimiting examples of suitable melt blending equipment include internal batch mixers, such as a BANBURY™ or BOLLING™ internal mixer. Alternatively, continuous single or twin screw mixers can be used, such as a FARREL™ continuous mixer, a COPERION™ twin screw mixer, or a BUSS™ kneading continuous extruder. The components are mixed at a temperature and for a length of time sufficient to fully homogenize the mixture. The type of mixer utilized, and the operating conditions of the mixer, will affect properties of the composition such as viscosity, and extruded surface smoothness.

The adhesive composition may be applied as a melt onto one or both substrates to adhesively bond the substrates upon solidification. The adhesive composition may exclude a solvent so as to be a non-solvent based adhesive composition.

In an embodiment, the adhesive composition includes

(A) from 1 wt % to 15 wt % of the block composite compatibilizer;

(B) from 25 wt % to 50 wt % of the ethylene-based polymer;

(C) from 30 wt % to 50 wt % tackifier; and

(D) from 10 wt % to 30 wt % wax.

In an embodiment, the adhesive composition includes

(A) from 2 wt % to 10 wt % of the block composite compatibilizer;

(B) from 30 wt % to 40 wt % of an ethylene-based polymer;

(C) from 35 wt % to 45 wt % tackifier; and

(D) from 15 wt % to 25 wt % wax.

### 3. Article

The present article includes the first substrate bonded to the second substrate by way of the adhesive composition. The present adhesive composition bonds the first substrate to the second substrate at a lap shear strength from 33.0 megaPascals (MPa) or 35.0 MPa, or 40.0 MPa, or 45.0 MPa, or 50.0 MPa to 55.0 MPa, or 60.0 MPa, or 65.0 MPa, or 70.0 MPa, or 80.00 MPa.

The first substrate includes the first propylene-based polymer and the second substrate includes the second propylene-based polymer as discussed above. The first propylene-based polymer may be the same or different than the second propylene-based polymer as disclosed above.

Each substrate may be composed solely of the respective propylene-based polymer.

In an embodiment, one or both substrates may contain one or more materials in addition to the respective (first or second) propylene-based polymer.

Each substrate may be a component (or sub-component) of a respective first object and second object. The object may include materials other than the propylene-based polymer present in each respective substrate. Nonlimiting examples of suitable materials for the objects (or the one or more materials) include metal (steel, aluminum) metal foil, wood, glass, polymeric material (such as polyolefin, acrylonitrile butadiene styrene (ABS), thermoplastic, elastomer, polycarbonate, polyurethane), polyvinyl chloride, foam/foam laminate, fabric (woven, non-woven, natural, synthetic), textile, paper, and any combination thereof. For non-wovens assembly adhesives, e.g., for the manufacture of sanitary articles such as infant and adult diapers, sanitary napkins, incontinent pads, bed pads, feminine pads, and panty shields.

In an embodiment, the first substrate includes a rigid material and the second substrate includes a flexible material. A “rigid material” is a material that resists deformation in response to an applied force. As used herein, a “flexible material” is a material that has less resistance to deformation than the aforementioned rigid material. In other words, the flexible material exhibits greater pliability or flexibility compared to the rigid material.

The present disclosure provides another article. In an embodiment, the article includes a first substrate comprising a first propylene-based polymer, a second substrate comprising a second propylene-based polymer. An adhesive composition is located between the first substrate and the second substrate. The adhesive composition comprises (A) a block composite, (B) a propylene-based polymer, (C) a tackifier, and (D) a wax. The adhesive composition bonds the first substrate to the second substrate with a lap shear strength from 10.0 MPa to 15.0 MPa.

The first substrate and the second substrate can be any substrate as previously disclosed herein. The first propylene-based polymer and the second propylene-based polymer can be any respective first propylene-based polymer and second propylene-based polymer as previously disclosed herein.

Regarding the adhesive composition, the BCC, the tackifier and the wax can be any respective BCC, tackifier, and wax as previously disclosed herein. In essence, the second article contains a propylene-based polymer for component (B) in the adhesive composition as opposed to an ethylene-based polymer for component (B) as discussed in the previously-described article.

### 4. Propylene-Based Polymer

The adhesive composition includes a propylene-based polymer in addition to the BCC, the tackifier, and the wax. The propylene-based is present in the adhesive composition to the exclusion of an ethylene-based polymer (with exception to the BCC which contains an ethylene-based polymer). The propylene-based polymer is present in the adhesive composition in an amount from 10 wt %, or 15 wt %, or 20 wt %, or 25 wt %, or 30 wt % to 35 wt %, or 40 wt %, or 45 wt %, or 50 wt %, or 55 wt %, or 60 wt %, based on the total weight of the adhesive composition.

Exemplary propylene-based polymers include propylene homopolymers, propylene interpolymers, as well as reactor copolymers of polypropylene (RCPP), which can contain about 1 to about 20 weight percent ethylene or an alpha-olefin comonomer of 4 to 20 carbon atoms (e.g., C₂ and C₄-C₁₀ alpha-olefins). The propylene-based interpolymer can be a random or block copolymer, or a propylene-based terpolymer. Examplary, comonomers for polymerizing with propylene include ethylene, 1-butene, 1-pentene, 1-hexene, 1-heptene, 1-octene, 1-nonene, 1-decene, 1-unidecene, 1 dodecene, as well as 4-methyl-1-pentene, 4-methyl-1-hexene, 5-methyl-1-hexene, vinylcyclohexane, and styrene. Exemplary comonomers include ethylene, 1-butene, 1-hexene, and 1-octene.

Exemplary propylene-based interpolymers include propylene/ethylene, propylene/1-butene, propylene/1-hexene, propylene/4-methyl-1-pentene, propylene/1-octene, propylene/ethylene/1-butene, propylene/ethylene/EN B, propylene/ethylene/1-hexene, propylene/ethylene/1-octene, propylene/styrene, and propylene/ethylene/styrene.

Optionally, the propylene-based polymer include a monomer having at least two double bonds such as dienes or trienes. Exemplary diene and triene comonomers include 7-methyl-1,6-octadiene; 3,7-dimethyl-1,6-octadiene; 5,7-dimethyl-1,6-octadiene; 3,7,11-trimethyl-1,6,10-octatriene; 6-methyl-1,5heptadiene; 1,3-butadiene; 1,6-heptadiene; 1,7-octadiene; 1,8-nonadiene; 1,9-decadiene; 1,10-undecadiene; norbornene; tetracyclododecene; or mixtures thereof. Exemplary embodiments include a butadiene, a hexadienes, and/or an octadiene. Examples include 1,4-hexadiene; 1,9-decadiene; 4-methyl-1,4-hexadiene; 5-methyl-1,4-hexadiene; dicyclopentadiene; and 5-ethylidene-2-norbornene (ENB).

Other unsaturated comonomers include, e.g., 1,3-pentadiene, norbornadiene, and dicyclopentadiene; C₈₋₄₀ vinyl aromatic compounds including styrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene.

Exemplary propylene-based polymers are formed by means within the skill in the art, for example, using single site catalysts (metallocene or constrained geometry) or Ziegler Natta catalysts. Exemplary, polypropylene polymers include KS 4005 polypropylene copolymer (previously available from Solvay); KS 300 polypropylene terpolymer (previously available from Solvay); L-Modu™ polymers, available from Idemistu, and VERSIFY™ polymers, available from The Dow Chemical Company. The propylene and comonomers, such as ethylene or alpha-olefin monomers may be polymerized under conditions within the skill in the art, for instance, as disclosed by Galli, et al., Angew. Macromol. Chem., Vol. 120, 73 (1984), or by E. P. Moore, et al. in Polypropylene Handbook, Hanser Publishers, New York, 1996, particularly pages 11-98.

The propylene-based polymer may have a Brookfield viscosity of less than 50,000 centipoise (cP) (e.g., less than 15,000 cP and/or less than 10,000 cP) at 350° F./177° C. as measured using a Brookfield viscometer. For example, the propylene-based copolymer has a Brookfield viscosity from 1000 cP to 19,000 cP, 1000 cP to 15,000 cP, 1000 cP to 12,000 cP, 1000 cP to 10,000 cP, and/or 5,000 cP to 10,000 cP. The propylene-based interpolymer may have a melt flow rate (MFR) from 5 to 3000 g/10 min, or from 50 to 3000 g/10 min, or from 200 to 2000 g/10 min, or from 200 to 1000 g/10 min, or from 200 to 500 g/10 min.

The propylene-based polymer may have an average molar mass of less than 100,000 g/mole, less than 90,000 g/mole, less than 85,000 g/mole, and/or less than 80,000 g/mole. For example, the average molar mass may be from 15,000 g/mole to 90,000 g/mole (e.g., 30,000 g/mole to 90,000 g/mole, 40,000 g/mole to 90,000 g/mole, 50,000 g/mole to 90,000 g/mole, 60,000 g/mole to 90,000 g/mole, 60,000 g/mole to 80,000 g/mole, and/or 70,000 g/mole to 80,000 g/mole).

The propylene-based polymer may have a density of 0.900 g/cc or less. For example, the density of the propylene-based copolymer is from 0.850 g/cc to 0.900 g/cc, from 0.860 g/cc to 0.895 g/cc, from 0.870 g/cc to 0.890 g/cc, from 0.850 g/cc to 0.880 g/cc, from 0.850 g/cc to 0.870 g/cc, and/or from 0.860 g/cc to 0.870 g/cc. In an exemplary embodiment, the density of the propylene-based polymer is from 0.870 g/cc to 0.900 g/cc.

The propylene-based polymer may have a melting temperature (Tm) typically of less than 120° C. and a heat of fusion (Hf) typically of less than 70 Joules per gram (J/g) as measured by differential scanning calorimetry (DSC) as described in U.S. Pat. No. 7,199,203.

The propylene-based polymer have a narrow molecular weight distribution (MWD), e.g., less than or equal to 4, or less than or equal to 3.5, less than or equal to 3, and/or less than or equal to 2.5. Propylene-based polymers of narrow MWD are formed by means within the skill in the art. Propylene-based polymers having a narrow MWD can be advantageously provided by visbreaking or by manufacturing reactor grades (non visbroken) using single-site catalysis, or by both methods.

The propylene-based polymer can be reactor-grade, visbroken, branched or coupled to provide increased nucleation and crystallization rates. The term “coupled” is used herein to refer to propylene-based polymers which are rheology-modified, such that they exhibit a change in the resistance of the molten polymer to flow during extrusion (for example, in the extruder immediately prior to the annular die). Whereas “visbroken” is in the direction of chain-scission, “coupled” is in the direction of crosslinking or networking. As an example of coupling, a couple agent (for example, an azide compound) is added to a relatively high melt flow rate polypropylene polymer, such that after extrusion, the resultant polypropylene polymer composition attains a substantially lower melt flow rate than the initial melt flow rate.

The propylene-based polymer may include propylene/alpha-olefin interpolymer (e.g., propylene/alpha-olefin copolymer), which is characterized as having substantially isotactic propylene sequences. “Substantially isotactic propylene sequences” means that the sequences have an isotactic triad (mm) measured by ¹³C NMR of greater than 0.85; in the alternative, greater than 0.90; in another alternative, greater than 0.92; and in another alternative, greater than 0.93. Isotactic triads are well-known in the art and are described in, for example, U.S. Pat. No. 5,504,172 and International Publication No. WO 2000/001745, which refers to the isotactic sequence in terms of a triad unit in the copolymer molecular chain determined by ¹³C NMR spectra.

Exemplary propylene-based polymers include VERSIFY™ polymers (The Dow Chemical Company) and VISTAMAXX™ polymers (ExxonMobil Chemical Co.), LICOCENE™ polymers (Clariant), EASTOFLEX™ polymers (Eastman Chemical Co.), REXTAC™ polymers (Hunstman), L-Modu polymers (Idemistu), and VESTOPLAST™ polymers (Degussa).

In an embodiment, the propylene-based polymer is a propylene/ethylene copolymer having one, some or all of the following properties:

(i) a density from 0.860 g/cc, or 0.870 g/cc, or 0.875 g/cc, or 0.880 g/cc;

(ii) a melt from rate (MFR) from 10 g/10 min, or 15 g/cc min to 20 g/10 min, or 25 g/10 min, or 30 g/10 min; and

(iii) a melting point, Tm, from 80° C., or 82° C., or 84° C. to 86° C., or 88° C.

In an embodiment, the propylene-based polymer for the adhesive composition is VERSIFY™ 4200, available from The Dow Chemical Company.

In an embodiment, the adhesive composition includes BCC with

(i) a hard polymer that includes propylene;

(ii) a soft polymer that includes ethylene; and

(iii) a block copolymer having a soft block and a hard block, the hard block of the block copolymer having the same composition as the hard polymer (i) and the soft block of the block copolymer having the same composition as the soft polymer (ii).

In an embodiment, the adhesive composition includes BCC with

(i) from 30 wt % to 70 wt % hard polymer comprising greater than 90 mol % propylene;

(ii) from 30 wt % to 70 wt % soft polymer comprising greater than 60 mol % ethylene; and

(iii) the block copolymer.

In an embodiment, the BCC of the adhesive composition includes block copolymer (iii) having 50/50 soft block/hard block ratio, the soft block comprising greater than or equal to 65 wt % ethylene and the hard block comprising from 1 wt % to 6 wt % ethylene.

In an embodiment, the adhesive composition includes

(A) from 1 wt % to 15 wt % of the block composite compatibilizer;

(B) from 30 wt % to 50 wt % of the propylene-based polymer;

(C) from 15 wt % to 25 wt % tackifier; and

(D) from 20 wt % to 40 wt % wax.

In an embodiment, the adhesive composition includes

(A) from 2 wt % to 10 wt % of the block composite compatibilizer;

(B) from 30 wt % to 40 wt % of an propylene-based polymer;

(C) from 17 wt % to 22 wt % tackifier; and

(D) from 30 wt % to 35 wt % wax.

### 5. Article

The present article with propylene-based polymer in the adhesive composition includes the first substrate bonded to the second substrate by way of the adhesive composition. The article can be any article as previously disclosed herein. The present adhesive composition bonds the first substrate to the second substrate at a lap shear strength from 10.0 MPa, or 11.0 MPa, or 12.0 MPa, or 13.0 MPa to 14.0 MPa or 15.0 MPa.

For the present article with propylene-based polymer in the adhesive composition, the substrate may be a component (or sub-component) of a respective object as previously disclosed herein. The object may include materials other than the propylene-based polymer present in each respective substrate as previously disclosed herein.

By way of example, and not limitation, examples of the present disclosure are provided.

### EXAMPLES

### Test Methods

Lap Shear Test is measured in accordance with ISO 4587 and utilizes the following procedure. The specimen is tested in a tensile testing machine. The specimen consists of two rigid propylene-based polymer substrates bonded together by the present adhesive composition. The bonding area is an overlapping area of the two substrates, the bonding area having dimensions of 2 cm×2 mm×1 mm thick. Adhesion is measured using an INSTRON testing machine. The lap shear strength is determined by the maximum force (in megaPascals, MPa) that causes adhesion failure and separation of the joined and bonded substrates.

At least five specimens for each sample are tested in the case of isotropic materials. The average of the test results from five specimens are recorded and reported.

Molecular weight distribution (MWD) is measured using Gel Permeation Chromatography (GPC). In particular, conventional GPC measurements are used to determine the weight-average (Mw) and number-average (Mn) molecular weight of the polymer, and to determine the MWD (which is calculated as Mw/Mn). Samples are analyzed with a high-temperature GPC instrument (Polymer Laboratories, Inc. model PL220). The method employs the well-known universal calibration method, based on the concept of hydrodynamic volume, and the calibration is performed using narrow polystyrene (PS) standards, along with four Mixed A 20 μm columns (PLgel Mixed A from Agilent (formerly Polymer Laboratory Inc.)) operating at a system temperature of 140° C. Samples are prepared at a “2 mg/mL” concentration in 1,2,4-trichlorobenzene solvent. The flow rate is 1.0 mL/min, and the injection size is 100 microliters.

As discussed, the molecular weight determination is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science, Polymer Letters, Vol. 6, (621) 1968) to derive the following equation:

Mpolyethylene=a*(Mpolystyrene)^{b}

In this equation, a=0.4316 and b=1.0 (as described in Williams and Ward, J. Polym. Sc., Polym. Let., 6, 621 (1968)). Polyethylene equivalent molecular weight calculations were performed using VISCOTEK TriSEC software Version 3.0.

Differential Scanning Calorimetry (DSC) is used to measure crystallinity in the polymers (e.g., ethylene-based (PE) polymers). About 5 to 8 mg of polymer sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE (230° C. for polypropylene or “PP”). The sample is kept at this temperature for three minutes. Then the sample is cooled at a rate of 10° C./min to −60° C. for PE (−40° C. for PP), and kept isothermally at that temperature for three minutes. The sample is next heated at a rate of 10° C./min, until complete melting (second heat). The percent crystallinity is calculated by dividing the heat of fusion (H_{f}), determined from the second heat curve, by a theoretical heat of fusion of 292 J/g for PE (165 J/g, for PP), and multiplying this quantity by 100 (for example, % cryst.=(H_{f}/292 J/g)×100 (for PE)).

Unless otherwise stated, melting point(s) (Tₘ) of each polymer is determined from the second heat curve (peak Tm), and the crystallization temperature (Tₐ) is determined from the first cooling curve (peak Tc).

The temperature at the maximum heat flow rate with respect to a linear baseline is used as the melting point. The linear baseline is constructed from the beginning of the melting (above the glass transition temperature) and to the end of the melting peak. The temperature is raised from room temperature to 200° C. at 10° C./min, maintained at 200° C. for 5 min, decreased to 0° C. at 10° C./min, maintained at 0° C. for 5 min and then the temperature is raised from 0° C. to 200° C. at 10° C./min, and the data are taken from this second heating cycle.

High Temperature Liquid Chromatography is performed according to the published method with minor modifications (Lee, D.; Miller, M. D.; Meunier, D. M.; Lyons, J. W.; Bonner, J. M.; Pell, R. J.; Shan, C. L. P.; Huang, T. J. Chromatogr. A 2011, 1218, 7173). Two Shimadzu (Columbia, Md., USA) LC-20AD pumps are used to deliver decane and trichlorobenzene (TCB) respectively. Each pump is connected to a 10:1 fixed flow splitter (Part #: 620-PO20-HS, Analytical Scientific Instruments Inc., CA, USA). The splitter has a pressure drop of 1500 psi at 0.1 mL/min in H₂O according to the manufacturer. The flow rates of both pumps are set at 0.115 mL/min. After the splitting, the minor flow is 0.01 mL/min for both decane and TCB, determined by weighing the collected solvents for more than 30 min. The volume of the collected eluent is determined by the mass and the densities of the solvents at room temperature. The minor flow is delivered to the HTLC column for separation. The main flow is sent back to the solvent reservoir. A 50-μL mixer (Shimadzu) is connected after the splitters to mix the solvents from Shimadzu pumps. The mixed solvents are then delivered to the injector in the oven of Waters (Milford, Mass., USA) GPCV2000. A Hypercarb™ column (2.1×100 mm, 5 μm particle size) is connected between the injector and a 10-port VICI valve (Houston, Tex., USA). The valve is equipped with two 60-μL sample loops. The valve is used to continuously sample eluent from the first dimension (D1) HTLC column to the second dimension (D2) SEC column. The pump of Waters GPCV2000 and a PLgel Rapid™-M column (10×100 mm, 5 μm particle size) are connected to the VICI valve for D2 size exclusion chromatography (SEC). The symmetric configuration is used for the connections as described in the literature (Van der Horst, A.; Schoenmakers, P. J. J. Chromatogra. A 2003, 1000, 693). A dual-angle light scattering detector (PD2040, Agilent, Santa Clara, Calif., USA) and an IR5 inferred absorbance detector are connected after the SEC column for measurement of concentration, composition, and molecular weight.

### Separation for HTLC

Approximately 30 mg are dissolved in 8-mL decane by gently shaking the vial at 160° C. for 2 hours. The decane contains 400 ppm BHT(2,6-Di-tert-butyl-4-methylphenol) as the radical scavenger. The sample vial is then transferred to the autosampler of GPCV2000 for injection. The temperatures of the autosampler, the injector, both the Hypercarb and the PLgel columns, the 10-port VICI valve, and both the LS and IR5 detectors are maintained at 140° C. throughout the separation.

The initial conditions before injection are as follows. The flow rate for the HTLC column is 0.01 mL/min. The solvent composition in the D1 Hypercarb column is 100% decane. The flow rate for the SEC column is 2.51 mL/min at room temperature. The solvent composition in the D2 PLgel column is 100% TCB. The solvent composition in the D2 SEC column does not change throughout the separation.

A 311-μL aliquot of sample solution is injected into the HTLC column. The injection triggers the gradient described below:

From 0-10 min, 100% decane/0% TCB;

From 10-651 min, TCB is increased linearly from 0% TCB to 80% TCB.

The injection also triggers the collection of the light scattering signal at 150 angle (LS15) and the “measure” and “methyl” signals from IR5 detector (IRₘₑₐₛᵤᵣₑ and IR_{methyl}) using EZChrom™ chromatography data system (Agilent). The analog signals from detectors are converted to digital signals through a SS420X analog-to-digital converter. The collection frequency is 10 Hz. The injection also triggers the switch of the 10-port VICI valve. The switch of the valve is controlled by the relay signals from the SS420X converter. The valve is switched every 3 min. The chromatograms are collected from 0 to 651 min. Each chromatogram consist of 651/3=217 SEC chromatograms.

After the gradient separation, 0.2 mL of TCB and 0.3 mL of decane are used to clean and re-equilibrate the HTLC column for next separation. The flow rate of this step is 0.2 mL/min, delivered by a Shimadzu LC-20 AB pump connected to the mixer.

### Data Analysis for HTLC

The 651 min raw chromatogram is first unfolded to give 217 SEC chromatograms. Each chromatogram is from 0 to 7.53 mL in the unit of 2D elution volume. The integration limit is then set and the SEC chromatograms undergo spike removal, baseline correction, and smoothing. The process is similar to batch analysis of multiple SEC chromatograms in conventional SEC. The sum of all the SEC chromatograms is inspected to ensure both left side (upper integration limit) and right side (lower integration limit) of the peak were at the baseline as zero. Otherwise, the integration limit i adjusted to repeat the process.

Each SEC chromatogram n from 1 to 217 yields an X-Y pair in the HTLC chromatogram, where n is the fraction number:

Xₙ=elution volume (mL)=D1flow rate×n×t_{switch}
where t_{switch}=3 min is the switch time of the 10-port VICI valve.

$${Y}_{n} = signal intensity ( Voltage ) = {\sum }_{peak start}^{peak end} {IR}_{measure , n}$$

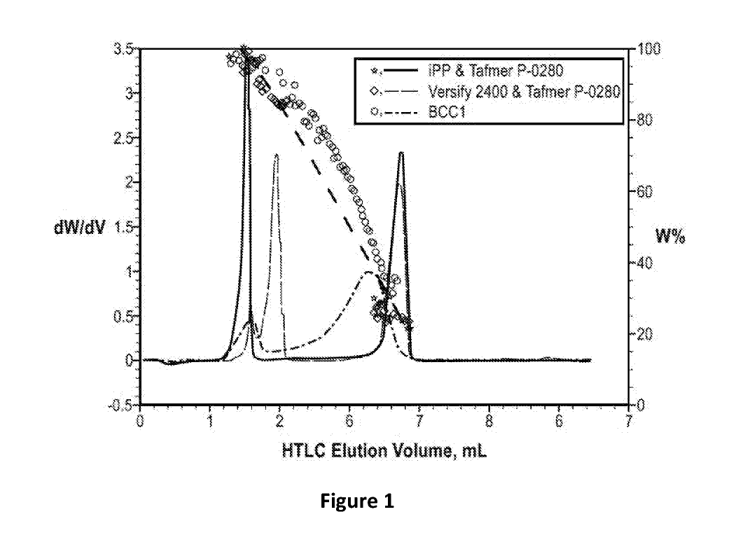

The above equation uses IRₘₑₐₛᵤᵣₑ signal as the example. The obtained HTLC chromatogram shows the concentrations of the separated polymeric components as a function of elution volume. The normalized IRₘₑₐₛᵤᵣₑ HTLC chromatogram is shown in FIG. 1 with Y represented by dW/dV, meaning the normalized weight fractions with respect to the elution volume.

X-Y pairs of data are also obtained from IR_{methyl} and LS15 signals. The ratio of IR_{methyl}/IRₘₑₐₛᵤᵣₑ is used to calculate composition after calibration. The ratio of LS15/IRₘₑₐₛᵤᵣₑ is used to calculate weight-average molecular weight (M_{w}) after calibration.

Calibration follows the procedures of Lee et al., ibid. High density polyethylene (HDPE), isotactic polypropylene (iPP), and ethylene-propylene copolymer with propylene contents of 20.0, 28.0, 50.0, 86.6, 92.0, and 95.8 wt % P are used as the standards for IR_{methyl}/IRₘₑₐₛᵤᵣₑ calibration. The composition of the standards are determined by NMR. The standards are run by SEC with IR5 detector. The obtained IR_{methyl}/IRₘₑₐₛᵤᵣₑ ratios of the standards are plotted as a function of their compositions, yielding the calibration curve.

The HDPE reference is used for routine LS15 calibration. The M_{w} of the reference is predetermined by GPC as 104.2 kg/mol with LS and RI (refractive index) detectors. GPC uses NBS 1475 as the standard in GPC. The standard has a certified value of 52.0 kg/mol by NIST. Between 7 to 10 mg of the standard is dissolved in 8-mL decane at 160° C. The solution is injected to the HTLC column in 100% TCB. The polymer is eluted under constant 100% TCB at 0.01 mL/min. Therefore, the peak of the polymer appears at the HTLC column void volume. A calibration constant, Q, is determined from the total LS15 signals (A_{LS15}) and the total IRₘₑₐₛᵤᵣₑ signals (A_{IR,measure}):

$$Ω = \frac{{A}_{LS 15}}{{A}_{IR , measure} {M}_{w}}$$

The experimental LS15/IRₘₑₐₛᵤᵣₑ ratio is then converted to M_{w} through Q.

By way of example, three HTLC chromatograms are shown in FIG. 1. The long-short-long-short dotted line chromatogram is for BCC1. The solid line is the chromatogram for the blend of iPP and TAFMER™ P-0280 (an ethylene/alpha-olefin copolymer product with MI 3.2 is available from Mitsui Chemicals). The thin long-long dotted line is the chromatogram for the blend of VERSIFY™ 2400 (a propylene-ethylene copolymer available from The Dow Chemical Company) and TAFMER™ P-0280. The heavy dashed line is a linear regression fit of the chemical compositions of iPP, VERSIFY™ 2400, and TAFMER™ P-0280 versus their respective peak elution volumes. Note that VERSIFY™ 2400 has two peaks. The composition and elution volume of the main peak is used for the linear fit. The three polymers all have M_{w} above 80,000 Daltons.

Microstructure Index Estimation:

In adsorption based solvent gradient interaction chromatography (SGIC) separation of polymer, block copolymer is eluted later than the random copolymer of the same chemical composition (Brun, Y.; Foster, P. J. Sep. Sci. 2010, 33, 3501). In particular, the material used for the microstructure index estimation is separated into two fractions, i.e., a random copolymer and a block copolymer of the same chemical composition. The early eluting fraction, i.e., the first fraction, indicates the comparatively higher presence of random copolymers. The late eluting component, i.e., the second fraction, indicates the comparatively higher presence of block copolymers. The microstructure index is defined as:

$$Microstructure Index = \frac{1}{{\sum }_{peak start of component 1}^{peak end of component 2} {w}_{n} \frac{{Comp}_{n , random}}{{Comp}_{n , sample}}}$$

where wₙ is weight fraction of fraction n. Comp_{n, random} is the chemical composition (wt % P) of fraction n derived from the linear calibration curve (heavy dashed line in FIG. 1). The curve reaches 0 wt % P at 4.56 mL and 100 wt % P at 1.65 mL. The compositions beyond 4.56 mL are considered to be 0 wt % P. The compositions before 1.65 mL are considered to be 100 wt % P. Comp_{n,sample} is the chemical composition (wt % P) of fraction n measured from the sample.

¹³C NMR samples are prepared by adding approximately 2.6 g of a 50/50 mixture of tetrachloroethane-d2/orthodichlorobenzene that is 0.025M in chromium acetylacetonate (relaxation agent) to 0.2 g sample in a 10 mm NMR tube. The samples are dissolved and homogenized by heating the tube and its contents to 150° C. The data are collected using a Bruker 400 MHz spectrometer equipped with a Bruker Dual DUL high-temperature CryoProbe. The data is acquired using 160 scans per data file, a 6 second pulse repetition delay with a sample temperature of 120° C. The acquisition is carried out using spectral width of 25,000 Hz and a file size of 32K data points.

Melt viscosity is determined by ASTM D3236, which is incorporated herein by reference, using a Brookfield Laboratories DVII+ Viscometer equipped with disposable aluminum sample chambers. In general, a SC-31 spindle is used, suitable for measuring viscosities in the range of from 30 to 100,000 centipoise (cP). If the viscosity is outside this range, an alternate spindle should be used which is suitable for the viscosity of the polymer. A cutting blade is employed to cut samples into pieces small enough to fit into the 25.4 mm wide, 127 mm wide long samples chamber. The disposable tube is charged with 8-9 grams of polymer. The sample is placed in the chamber, which is in turn inserted into a Brookfield Thermosel and locked into place with bent needle-nose pliers. The sample chamber has a notch on the bottom that fits in the bottom of the Brookfield Thermosel to ensure that the chamber is not allowed to turn when the spindle is inserted and spinning. The sample is heated to the desired temperature (177° C./350° F.). The viscometer apparatus is lowered and the spindle submerged into the sample chamber. Lowering is continued until brackets on the viscometer align on the Thermosel. The viscometer is turned on, and set to a shear rate which leads to a torque reading in the range of 40 to 70 percent. Readings are taken every minute for about 15 minutes, or until the values stabilize, and then the final reading is recorded. The results are reported in centi poise (cP).

Tensile Properties are measured using ASTM D-638, which covers the determination of the tensile properties of plastics in the form of standard dumbbell-shaped test specimens when tested under defined conditions of pretreatment, temperature, humidity, and testing machine speed. At least five specimens for each sample are tested in the case of isotropic materials. Condition all the test specimens in accordance with Procedure A of Practice D618. Conduct the tests at the same temperature and humidity used for conditioning. Sample dimensions are then measured using a caliper. A testing machine (such as INSTRON™) is used to detect stress as a function of elongation by placing the specimen in the grips of the testing machine, taking care to align the long axis of the specimen with the grips. Modulus of materials is determined from the slope of the linear portion of the stress-strain curve which is determined using a Class B-2 or better extensometer. For most plastics, this linear portion is very small, occurs very rapidly, and must be recorded automatically. Tensile Strength is calculated by dividing the maximum load in Newtons (pounds-force) by the average original cross-sectional area in the gage length segment of the specimen in square meters (square inches). Percent Elongation at Break is calculated by reading the extension (change in gage length) at the point of specimen rupture. Divide that extension by the original gage length and multiply by 100.

Polypropylene equivalent molecular weight calculations are performed using Viscotek TriSEC software Version 3.0.

Fiber Tear (%) Percent fiber tear (FT) of adhesives using Inland corrugated cardboard is determined according to a standardized method. A bead of adhesive is applied on to a cardboard coupon (5×6 cm) using an Olinger Bond Tester and a second coupon is quickly placed on top of the adhesive. Light finger pressure for ca. 3 seconds is applied to hold the bond in place. Samples are conditioned for at least 4 hours at room temperature and 50% relative humidity. Next, samples are conditioned at the test temperatures for 5 hrs to 24 hrs. Samples (n=5) are pulled apart by hand and the failure mode (fiber tear, cohesive failure, adhesive failure) is recorded.

Gel permeation chromatographic (GPC) system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000, and 0.05 grams in 50 milliliters of solvent for molecular weights less than 1,000,000. The polystyrene standards are dissolved at 80-C with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)): M_{polypropylene}=0.645(M_{polystyrene}).

### Materials

Catalyst ([[rel-2′,2″′-[(1R,2R)-1,2-cylcohexanediylbis(methyleneoxy-kO)] bis[3-(9H-carbazol-9-yl)-5-methyl[1,1′-biphenyl]-2-olato-kO]](2-)]dimethyl-hafnium) and Cocatalyst-1, a mixture of methyldi(C₁₄₋₁₈ alkyl)ammonium salts of tetrakis(pentafluorophenyl)borate, prepared by reaction of a long chain trialkylamine (Armeen™ M2HT, available from Akzo-Nobel, Inc.), HCl and Li[B(C₆F₅)₄], substantially as disclosed in U.S. Pat. No. 5,919,9883, Ex. 2., are purchased from Boulder Scientific and used without further purification.

CSA-1 (diethylzinc or DEZ) and Cocatalyst-2 (modified methylalumoxane (MMAO)) are purchased from Akzo Nobel and used without further purification.

The block composite compatibilizer is prepared using two continuous stirred tank reactors (CSTR) connected in series. Each reactor is hydraulically full and set to operate at steady state conditions. Monomers, solvent, catalyst-1, cocatalyst-1, cocatalyst-2, and CSA-1 are flowed to the first reactor according to the process conditions outlined in Table 1. The first reactor contents as described in Table 1 are flowed to a second reactor in series. Additional catalyst-1, cocatalyst-1, and cocatalyst-2 are added to the second reactor.

TABLE 1
Process Conditions for Block Composite Compatibilizer (BCC1)

| Condition | 1^{st} reactor (RX1) | 2^{nd} reactor (RX2) |
|---|---|---|
| Reactor Control Temp. (° C.) | 105 | 117.1 |
| Solvent Feed (lb/hr) | 475.89 | 576.37 |
| Propylene Feed (lb/hr) | 30.37 | 82.45 |
| Ethylene Feed (lb/hr) | 57.47 | 4.77 |
| Reactor Propylene Conc. (g/L) | 2.1 | 2.43 |
| Hydrogen Feed (sccm) | 0 | 0 |
| Catalyst Flow (lb/hr) | 0.47 | 1.48 |
| Catalyst Conc. (ppm) | 250.01 | 250.01 |
| Cocatalyst-1 Flow (lb/hr) | 0.46 | 1.48 |
| Cocatalyst-1 Conc. (ppm) | 2343.32 | 2343.32 |
| Cocatalyst-2 Flow (lb/hr) | 0.53 | 0.28 |
| Cocatalyst-2 Conc. (ppm) | 994.69 | 1995.48 |
| DEZ Flow (lb/hr) | 3.00 | 0 |
| DEZ Concentration (ppm) | 49993.59 | 0 |

Referring to the above, BCC1 includes (i) a propylene/ethylene copolymer (hard), (ii) an ethylene/propylene copolymer (soft) and (iii) a EP-PE diblock composite comprising a hard block and a soft block with the designed composition shown in Table 2.

TABLE 2
Designed BCC1 composition

| RX1 wt % | RX2 wt % | RX1 wt % C2 | RX2 wt % C2 |
|---|---|---|---|
| 50 | 50 | 65 | 6 |

In FIG. 1, the long-short-long-short dotted line HTLC chromatogram represents BCC1. The solid line chromatogram represents a blend of iPP with Tafmer™ P-0280. The thin long-long dotted line chromatogram represents a blend of Versify™ 2400 with Tafmer™ P-0280. The dashed line is derived from a linear regression fit of chemical compositions of iPP, Versify™ 2400, and Tafmer™ P-0280 versus their respective elution volumes. The microstructure index, calculated from the ratio of online compositions of BCC1 to those derived from the linear regression fit, is 1.2 for BCC1.

TABLE 3
HTLC characterization of BCC1

| | | | | | | | Microstructure |
|---|---|---|---|---|---|---|---|
| | Composition Peak 1: wt % P > 70 | | | Composition Peak 2: wt % P < 70 | | | index Measured |
| | Concentration | Composition | Mw | Concentration | Composition | Mw | from HTLC online |
| | wt % | wt % P | Kg/mol | wt % | wt % P | kg/mol | composition |
| BCC1 | 15.9 | 95.5 | 40.8 | 84.1 | 56.9 | 78.9 | 1.2 |

Properties for BCC1 are provided in Table 4 below.

TABLE 4
Properties for BCC1, BCC2

| | | | | | Tm (° C.) | | Melt |
|---|---|---|---|---|---|---|---|
| | MFR | Mw | | Total | Peak 1 | Tc | Enthalpy |
| Example | (230° C./2.16 kg) | Kg/mol | Mw/Mn | wt % C₂ | (Peak 2) | (° C.) | (J/g) |
| BCC1 | 70.1 | 79.8 | 2.9 | 53.7 | 104.7 (44.6) | 47.6 | 28.6 |

Other materials used in the examples are provided in Table 5 below.

TABLE 5
Other Materials Used for Hot Melt Compositions

| Component | Specification | | Source |
|---|---|---|---|
| ENGAGE 8407 | Ethylene/octene random copolymer | | The Dow Chemical |
| | Properties | | Company |
| | MI 30 | | |
| | d 0.87 | | |
| | Shore A 72 | | |
| | Tensile strength at yield 2.8 | | |
| | Elongation at break >600% | | |
| | Tm 65° C. | | |
| Versify | MFR 25 | | The Dow Chemical |
| 4200 | d 0.876 | | Company |
| | Shore A 94 | | |
| | Tensile strength at yield 9 | | |
| | Elongation at break 850% | | |
| | Tm 84° C. | | |
| Versify | MFR 2.0 | | The Dow Chemical |
| 2400 | d 0.858 | | Company |
| | Shore A 75 | | |
| | Tm 55° C. | | |
| Tackifier | Tackifier-hydrogenated hydrocarbon | | Eastman |
| Eastotac 100W | resin | | |
| | Property | Test | |
| | Ring and Ball Softening Point | Method | |
| | Color, Gardner | ASTM E 28 | |
| | Color, Gardner (Molten) | ASTM D 1544 | |
| | Yellowness Index 1 cm cell | ASTM D 1544 | |
| | Density | ASTM E 313 | |

| | | |
|---|---|---|
| | Viscosity, Brookfield @ 190° C. | |
| | Form | |
| | Acid Number | |
| | Bulk Density | |
| | Bromine Number | |
| | Flash Point Cleveland Open Cup | |
| | Glass Transition Temperature (T_{g}) | |
| Wax | wax-Propylene Maleic Anhydride Copolymer, with a SAP | Honeywell |
| AC596P | # of 50, in pastille form | |

| | | |
|---|---|---|
| drop point | 145° | C. |
| viscosity at 170 C. | 60 | MPa · s |
| density | 0.90 | g/cc |
| acid value | 0 | mg KOH/g |

| | | |
|---|---|---|
| FT Wax | Wax-Fischer-Tropsch wax, white pellets | Sasol |

| | | | |
|---|---|---|---|
| Sasol H1 | Congealing Point | 96-100° | C. |
| | drop point | 108-114° | C. |
| | viscosity at 135 C. | 8 | MPa · s |
| | density | 0.94 | g/cc |
| | acid value | 0 | mg KOH/g |

| | | |
|---|---|---|
| Irganox ® 1010 | Antioxidant pentaerythritol tetrakis(3-(3,5-di-tert-butyl-4- | BASF |
| (AO) | hydroxyphenyl)propionate) | |
| | CAS 6683-19-8 | |

| | | |
|---|---|---|
| Density | 1.15 | g/cc |
| Flashpoint | 297° | C. |

### Example 1—Adhesive Composition with Ethylene-Based Polymer

BCC1 is blended with ethylene-octene random copolymer (ENGAGE™ 8407). Tackifer (Eastotac H100W) and wax (Sasol H1) are also used in the formulation for Example 1. Components for the adhesive composition are weighed into an aluminum can and preheated in an oven for 200° C. for one hour. The components in the can are then mixed in a heated block at 180° C. for half an hour with a Paravisc style mixer head at 100 rpm.

In Example A-2 (ENGAGE 8407 with 10% BCC1), exhibits up to 120% increase in lap shear strength in the presence of BCC1 compared to comparative sample A-0.

Comparing the MI of polymers and BCC in the adhesive compositions, the MI of BCC1 is 30, which is same as ENGAGE 8407(MI 30). When BCC1 is added to ENGAGE 8407 adhesives at 5 wt % and 10 wt %, the viscosity of adhesive compositions remains unchanged (compare comparative sample A-0 to Examples A-1 and A-2). Adhesion improvement is observed with the presence of BCC1, which is not attributed to any molecular weight effect. Bounded by no particular theory, it is believed adhesion improvement is the result of improved affinity between substrate and adhesive composition containing BCC1. BCC1 is believed to act as a compatibilizer between propylene-based polymer substrate and ethylene copolymer at the interface, which are otherwise incompatible to each other.

TABLE 6
BCC1 effect on Ethylene-Octene copolymer based adhesives
with Sasol wax

| | Sample No. | | |
|---|---|---|---|
| | A-0* | A-1 | A-2 |
| ENGAGE 8407 | 40 | 35 | 30 |
| BCC1 | 0 | 5 | 10 |
| Eastotac 100W | 39.5 | 39.5 | 39.5 |
| Sasol H1 | 20 | 20 | 20 |
| Irganox 1010 | 0.5 | 0.5 | 0.5 |
| Sum | 100 | 100 | 100 |
| Brookfield Viscosity | 579,000 | 629,000 | 612,000 |
| @177 C. (cp) | | | |
| Cap Shear Strength (MPa) | 32.6 | 51.1 | 72.5 |

*comparative sample

### Example 2—Adhesive Composition with Propylene-Based Polymer

BCC1 is blended with propylene-ethylene random copolymer (VERSIFY™ 4200). Sasol wax (samples D-1 through D-9) and polypropylene wax (samples D-4-1 through D-9-1) are used in different adhesive compositions in Table 7. BCC1 improves adhesion on polypropylene substrates in all formulations with both Sasol and PP waxes. The optimized bonding property is obtained in sample D-6-1 with 40 wt % VERSIFY 4200, 10 wt % BCC1 and 30 wt % polypropylene wax. Adhesive composition with MAH functionalized polypropylene wax (AC596P) shows better adhesion, compared with adhesives containing polyethylene wax. Bounded by no particular theory, the differences are from better wetting of the substrate with MAH functionalized polypropylene wax and better compatibility between MAH functionalized polypropylene wax and propylene-ethylene copolymer.

TABLE 7
BCC1 effect on propylene-ethylene copolymer based adhesives.

| Sample No. | D-1* | D-2 | D-3 | D-4* | D-5 | D-6 | D-7* | D-8 | D-9 | D-4-1* | D-5-1 | D-6-1 | D-7-1* | D-8-1 | D-9-1 |
|---|---|---|---|---|---|---|---|---|---|---|---|---|---|---|---|
| VERSIFY 4200 | 40 | 35 | 30 | 50 | 45 | 40 | 60 | 55 | 50 | 50 | 45 | 40 | 60 | 55 | 50 |
| BCC1 | 0 | 5 | 10 | 0 | 5 | 10 | 0 | 5 | 10 | 0 | 5 | 10 | 0 | 5 | 10 |
| Eastotac 100W | 39.5 | 39.5 | 39.5 | 19.5 | 19.5 | 19.5 | 19.5 | 19.5 | 19.5 | 19.5 | 19.5 | 19.5 | 19.5 | 19.5 | 19.5 |
| Sasol H1 | 20 | 20 | 20 | 30 | 30 | 30 | 20 | 20 | 20 | 0 | 0 | 0 | 0 | 0 | 0 |
| AC 596P | 0 | 0 | 0 | 0 | 0 | 0 | 0 | 0 | 0 | 30 | 30 | 30 | 20 | 20 | 20 |
| Irganox 1010 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Sum | 100 | 100 | 100 | 100 | 100 | 100 | 100 | 100 | 100 | 100 | 100 | 100 | 100 | 100 | 100 |
| Lap Shear Strength | 3.8 | 4.6 | 5.7 | 3.4 | 3.8 | 4.8 | 4.2 | 4.5 | 5.7 | 8.9 | 12.4 | 13.0 | 4.3 | 5.3 | 5.4 |
| (MPa) | | | | | | | | | | | | | | | |

*comparative sample

It is specifically intended that the present disclosure not be limited to the embodiments and illustrations contained herein, but include modified forms of those embodiments including portions of the embodiments and combinations of elements of different embodiments as come within the scope of the following claims.

1. An article comprising:
a first substrate comprising a first propylene-based polymer;
a second substrate comprising a second propylene-based polymer; and
an adhesive composition located between the first substrate and the second substrate, the adhesive composition comprising
(A) a block composite compatibilizer,
(B) an ethylene-based polymer,
(C) a tackifier, and
(D) a wax;
wherein the adhesive composition bonds the first substrate to the second substrate with a lap shear strength from 33.0 MPa to 80.0 MPa.

2. The article of claim 1 wherein the first propylene-based polymer and the second propylene-based polymer each is a propylene homopolymer.

3. The article of claim 1 wherein the block composite compatibilizer comprises:
(i) a hard polymer that includes propylene;
(ii) a soft polymer that includes ethylene; and
(iii) a block copolymer having a soft block and a hard block, the hard block of the block copolymer having the same composition as the hard polymer (i), and the soft block of the block copolymer having the same composition as the soft polymer (ii).

4. The article of claim 1 wherein the block composite compatibilizer comprises
(i) from 30 wt % to 70 wt % hard polymer comprising greater than 90 wt % propylene;
(ii) from 30 wt % to 70 wt % soft polymer comprising greater than 60 wt % ethylene; and
(iii) the block copolymer.

5. The article of claim 1 wherein the block copolymer (iii) comprises a 50/50 soft block/hard block ratio, the soft block comprising greater than or equal to 65 wt % ethylene and the hard block comprising from 1 wt % to 10 wt % ethylene.

6. The article of claim 1 wherein the adhesive composition comprises
(A) from 1 wt % to 15 wt % of the block composite compatibilizer;
(B) from 25 wt % to 50 wt % of the ethylene-based polymer;
(C) from 30 wt % to 50 wt % tackifier; and
(D) from 10 wt % to 30 wt % wax.

7. The article of claim 1 wherein the adhesive composition comprises
(A) from 2 wt % to 10 wt % of the block composite compatibilizer;
(B) from 30 wt % to 40 wt % of an ethylene-based polymer;
(C) from 35 wt % to 45 wt % tackifier; and
(D) from 15 wt % to 25 wt % wax.

8. The article of claim 1 wherein the ethylene-based polymer (B) is an ethylene/octene copolymer.

9. An article comprising:
a first substrate comprising a first propylene-based polymer;
a second substrate comprising a second propylene-based polymer; and
an adhesive composition located between the first substrate and the second substrate, the adhesive composition comprising
(A) a block composite compatibilizer,
(B) a propylene-based polymer,
(C) a tackifier, and
(D) a wax;
wherein the adhesive composition bonds the first substrate to the second substrate with a lap shear strength from 10.0 MPa to 15.0 MPa.

10. The article of claim 9 wherein the first propylene-based polymer and the second propylene-based polymer each is a propylene homopolymer.

11. The article of claim 9 wherein the block composite compatibilizer comprises:
(i) a hard polymer that includes propylene;
(ii) a soft polymer that includes ethylene; and
(iii) a block copolymer having a soft block and a hard block, the hard block of the block copolymer having the same composition as the hard polymer (i) and the soft block of the block copolymer having the same composition as the soft polymer (ii).

12. The article of claim 9 wherein the block composite compatibilizer comprises
(i) from 30 wt % to 70 wt % hard polymer comprising greater than 90 wt % propylene;
(ii) from 30 wt % to 70 wt % soft polymer comprising greater than 60 wt % ethylene; and
(iii) the block copolymer.

13. The article of claim 11 wherein the block copolymer (iii) comprises a 50/50 soft block/hard block ratio, the soft block comprising greater than or equal to 65 wt % ethylene and the hard block comprising from 1 wt % to 10 wt % ethylene.

14. The article of claim 9 wherein the adhesive composition comprises
(A) from 1 wt % to 15 wt % of the block composite compatibilizer;
(B) from 30 wt % to 50 wt % of the propylene-based polymer;
(C) from 15 wt % to 25 wt % tackifier; and
(D) from 20 wt % to 40 wt % wax.

15. The article of claim 9 wherein the adhesive composition comprises
(A) from 2 wt % to 10 wt % of the block composite compatibilizer;
(B) from 30 wt % to 40 wt % of the propylene-based polymer;
(C) from 17 wt % to 22 wt % tackifier; and
(D) from 30 wt % to 35 wt % wax.

16. The article of claim 9 wherein the propylene-based polymer is a propylene/ethylene copolymer.
